(19) United States
(12) Patent Application Publication
(10) Pub. No.: US 2020/0361170 A1
(43) Pub. Date: Nov. 19, 2020

(54) METHOD AND TOOL FOR TRIMMING A PART FROM A PLASTIC WEB

(71) Applicant: The Louis G. Freeman Company, LLC, Fremont, OH (US)

(72) Inventors: Larry Mears, Fremont, OH (US); Steffen Brown, Fremont, OH (US)

(73) Assignee: The Louis G. Freeman Company, LLC, Fremont, OH (US)

(21) Appl. No.: 16/876,400

(22) Filed: May 18, 2020

Related U.S. Application Data
(60) Provisional application No. 62/849,235, filed on May 17, 2019.

(51) Int. Cl. B31B 50/14; B31B 50/16; B31B 50/00

(52) U.S. Cl. CPC B31B 50/142; B31B 2120/102; B31B 50/005; B31B 50/16

(57) ABSTRACT

A method and tool for trimming a part formed in a plastic web comprises positioning the part formed in the plastic web between a tool comprising a first punch and die plate assembly and a second punch and die plate assembly. The first punch and die plate assembly comprises a base punch and a lid die plate. The base punch has an outer edge corresponding to an edge of a bottom surface of a base of the part. The lid die plate has an inner edge corresponding to an edge of a bottom surface of a lid of the part. The second punch and die plate assembly comprises a base die plate and a lid punch. The base die plate has an inner edge corresponding to an edge of a top surface of the base of the part. The lid punch has an outer edge corresponding to an edge of a top surface of the lid of the part. The method further comprises actuating the tool so that the first punch and die plate assembly and the second punch and die plate assembly sandwich the plastic web cutting at least a portion of the part from the plastic web.

### RELATED APPLICATION

The present non-provisional patent application claims priority to U.S. Provisional Patent Application Ser. No. 62/849,235 filed on May 17, 2019, and entitled “Bi-Directional Trim Concept,” the entirety of which is hereby incorporated by reference into the present application.

### BACKGROUND

When manufacturing a plastic part with a lid and base, the lid and base are often formed and trimmed in separate webs using different trimming tools. This is expensive because it requires different trimming and forming tools and costs associated with assembly and handling. To be able to trim the base and lid from the same web, a wide flange would have to be formed in the lid and the base. However, products having minuscule to no horizontal flange, such as products with tamper-evidence features, would have to be trimmed again to remove the wide flange. This would eliminate any cost savings associated with trimming the base and lid together.

The background discussion is intended to provide information related to the present invention which is not necessarily prior art.

### SUMMARY

The present invention solves the above-described problems and other problems and provides a distinct advance in the art of trimming plastic products. More particularly, embodiments of the present invention provide methods and systems for trimming a plastic part with a base and lid from the same plastic web without requiring wide flanges and extra trimming steps.

A method of trimming a part formed in a plastic web according to an embodiment of the present invention broadly comprises positioning the part formed in the plastic web in a tool comprising a first punch and die plate assembly and a second punch and die plate assembly. The first punch and die plate assembly comprises a base punch and a lid die plate. The base punch comprises an outer edge corresponding to an edge of a top surface of a base of the part. The lid die plate comprises an inner edge corresponding to an edge of a bottom surface of a lid of the part. The second punch and die plate assembly comprises a base die plate and a lid punch. The base die plate comprises an inner edge corresponding to an edge of a bottom surface of the base of the part. The lid punch comprises an outer edge corresponding to an edge of a top surface of the lid of the part.

The method further comprises actuating the tool so that the first punch and die plate assembly and the second punch and die plate assembly sandwich the plastic web cutting at least a portion of the part from the plastic web. By using bi-directional trimming via the pair of punch and die plate assemblies, the lid and base of the part can be trimmed from the web at one time, which reduces manufacturing and handling costs. Additionally, the bi-directional trimming enables trimming parts with little to no excess horizontal flanges.

Another embodiment of the invention is a tool for trimming a plastic part with a lid and a base. The tool comprises a first punch and die plate assembly and a second punch and die plate assembly. The first punch and die plate assembly comprises a base bunch and a lid die plate. The base punch comprises an outer edge corresponding to an edge of a top surface of the base of the part. The lid die plate comprises an inner edge corresponding to an edge of a bottom surface of the lid of the part. The second punch and die plate assembly comprises a base die plate and a lid punch. The base die plate comprises an inner edge corresponding to an edge of a bottom surface of the base of the part and operable to receive a portion of the base punch of the first punch and die plate assembly. The lid punch comprises an outer edge corresponding to an edge of a top surface of the lid of the part and operable to extend into the lid die plate of the first punch and die plate assembly.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is an elevated perspective view of an exemplary press system implementing a tool constructed according to an embodiment of the present invention;

FIG. 2 is an elevated perspective view of the exemplary press system of FIG. 1;

FIG. 3 is a top perspective view of a part trimmer by the tool of FIG. 1;

FIG. 4 is a bottom perspective view of the part of FIG. 3;

FIG. 5 is a partial view of a hinge of the part of FIG. 3;

FIG. 6 is a top perspective view of a web for trimming by the tool of FIG. 1;

FIG. 7 is an exploded view of the exemplary press system of FIG. 1;

FIG. 8 is a partial view of a first punch and die plate assembly of the tool of FIG. 1;

FIG. 9 is a partial view of a second punch and die plate assembly and an ejector of the tool of FIG. 1;

FIG. 10 is a partial view of the first punch and die plate assembly of FIG. 8;

FIG. 11 is a partial view of the second punch and die plate assembly of FIG. 9;

FIG. 12 is a partial view of the tool of FIG. 1 showing hinge slot nicks;

FIG. 13 is a partial view of the tool of FIG. 1 showing web retention slot nicks;

FIG. 14 is a side perspective view of the exemplary press system of FIG. 1 showing an ejector pressing against the part;

FIG. 15 is a side perspective view of the exemplary press system of FIG. 1 showing the ejector pressing the part away from the web;

FIG. 16 is a side perspective view of the exemplary press system of FIG. 1 showing the tool being actuated.

FIG. 17 is a partial view of the tool of FIG. 1 engaging the web;

FIG. 18 is a partial view of the tool of FIG. 1 trimming the part; and

FIG. 19 is a flowchart illustrating at least a portion of the steps for trimming a part according to an embodiment of the present invention.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

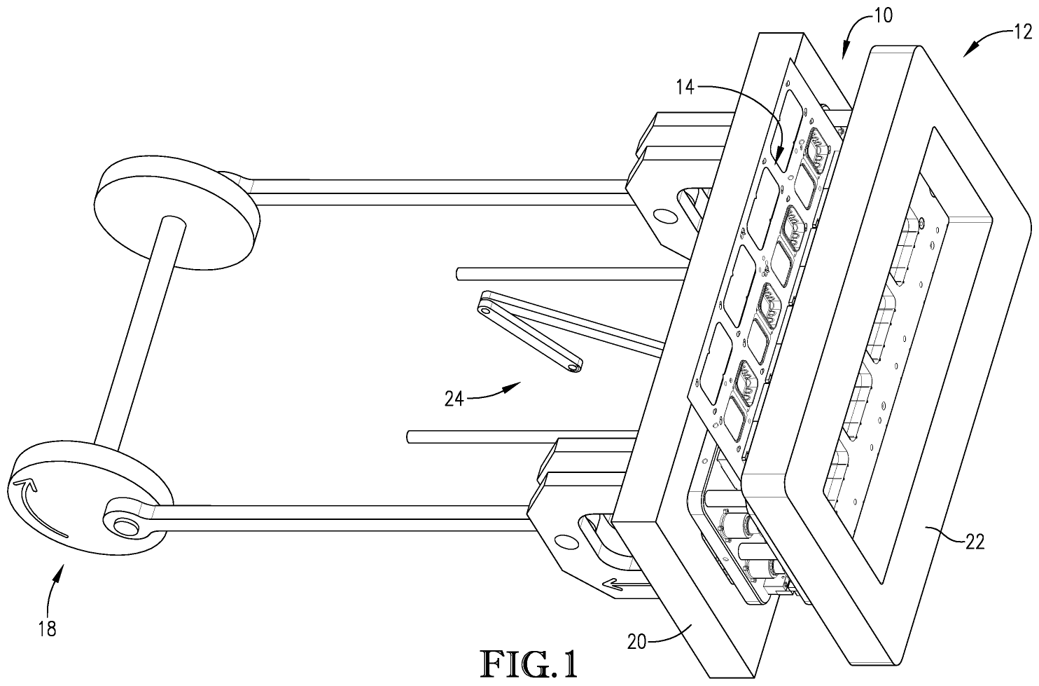

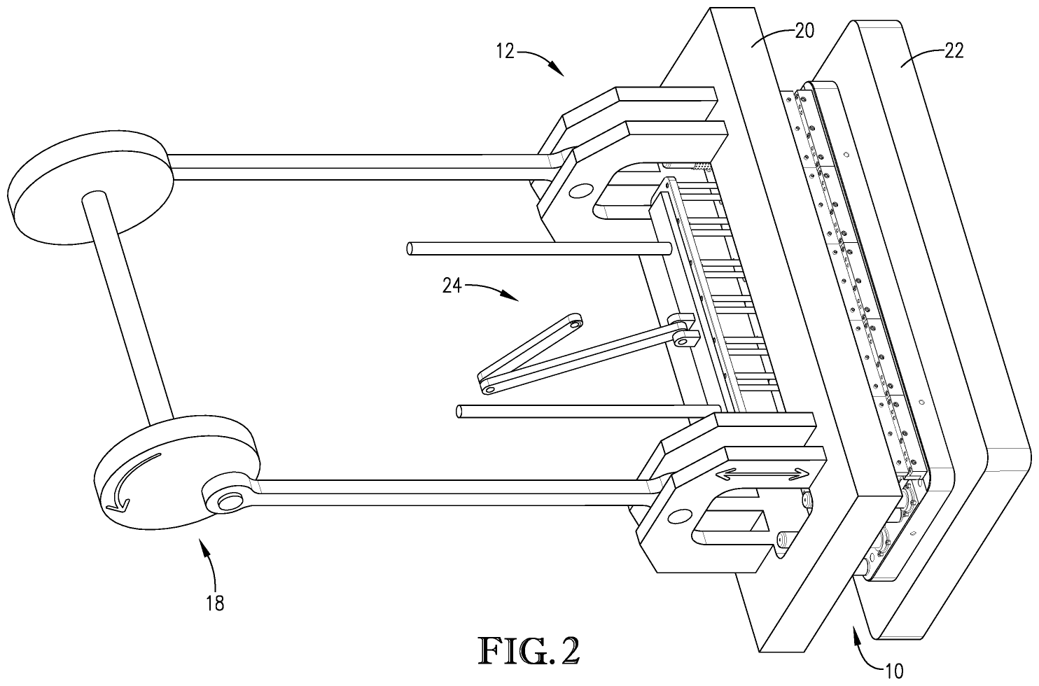

Turning to FIG. 1, an exemplary press system 12 implementing a tool 10 constructed in accordance with an embodiment of the invention is depicted. The system 12 is configured to receive a plastic web 14 having one or more parts 16 formed in the web 14 and actuate the tool 10 to trim and eject the parts 16 from the web 14. Turning to FIG. 2, the system 12 may include a drive system 18, a first platen 20, a second platen 22, and an ejector drive 24. The drive system 18 actuates one or more of the platens 20, 22 toward one another for causing the tool 10 to trim the parts 16. The platens 20, 22 support the tool 10, and the ejector drive 24 ejects trimmed parts 16 from the web 14. The system 12 may actuate the tool 10 at any orientation without departing from the scope of the present invention. For example, the drive system 18 may extend horizontally and retract one or more of the platens 20, 22. Alternatively, the drive system 18 may extend and retract one or more of the platens 20, 22 vertically. Additionally, the drive system 18 may actuate either or both of the platens 20, 22 without departing from the scope of the present invention. For example, the drive system 18 may be configured to only actuate platen 20.

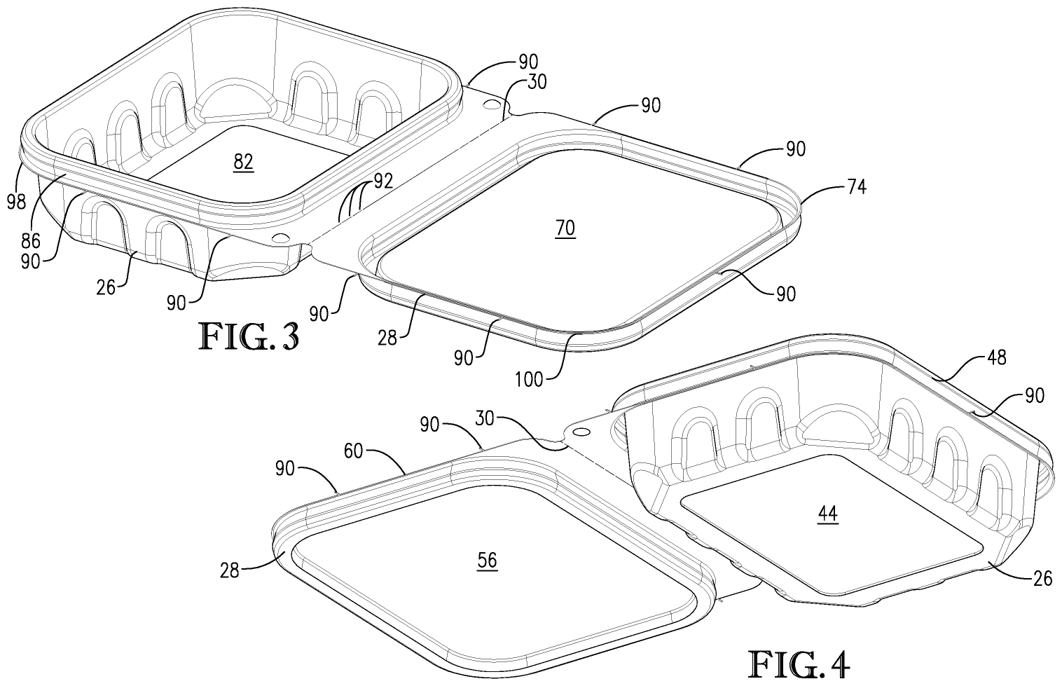

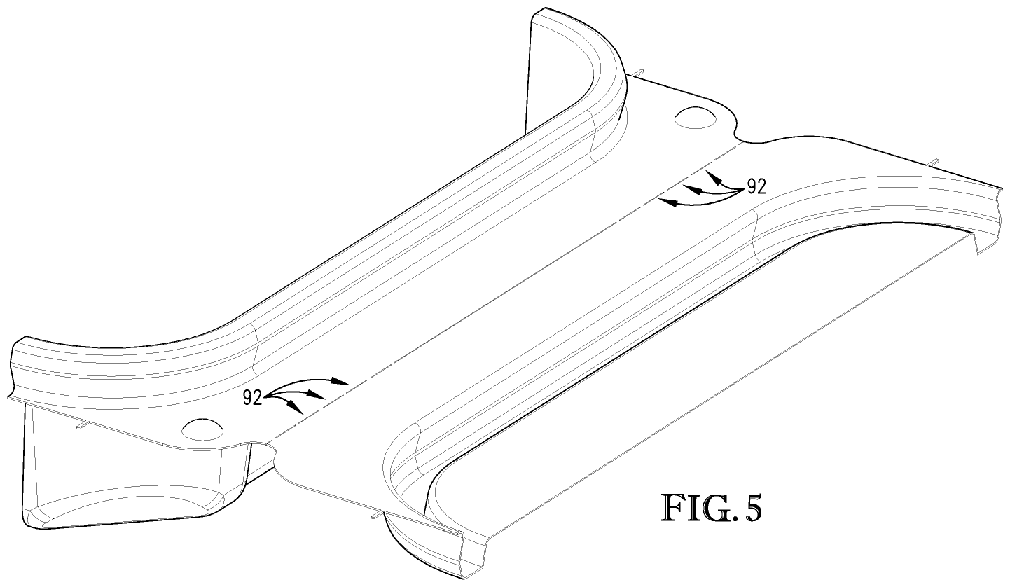

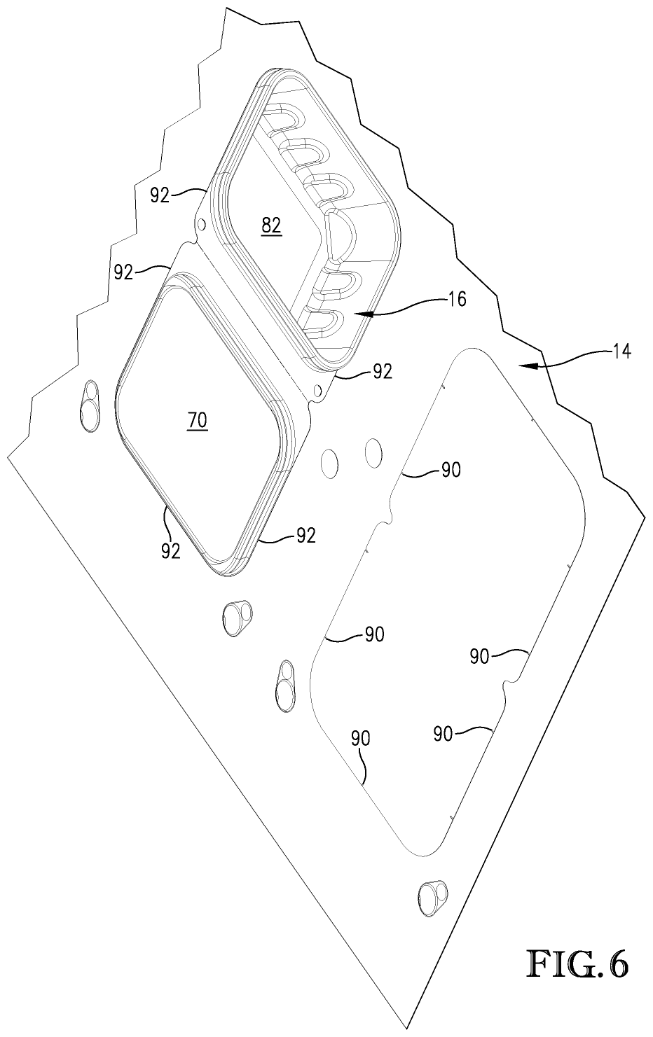

Turning to FIGS. 3-6, the parts 16 may comprise a base 26, a lid 28, and a hinge 30 connecting the lid 28 to the base 26. The parts 16 may be integral and formed from the same web 14. However, the parts 16 may have any number of configurations without departing from the scope of the present invention. For example, the base 26 and lid 28 may be separated or connected to one another via a detachable portion, such as a perforated strip of web material.

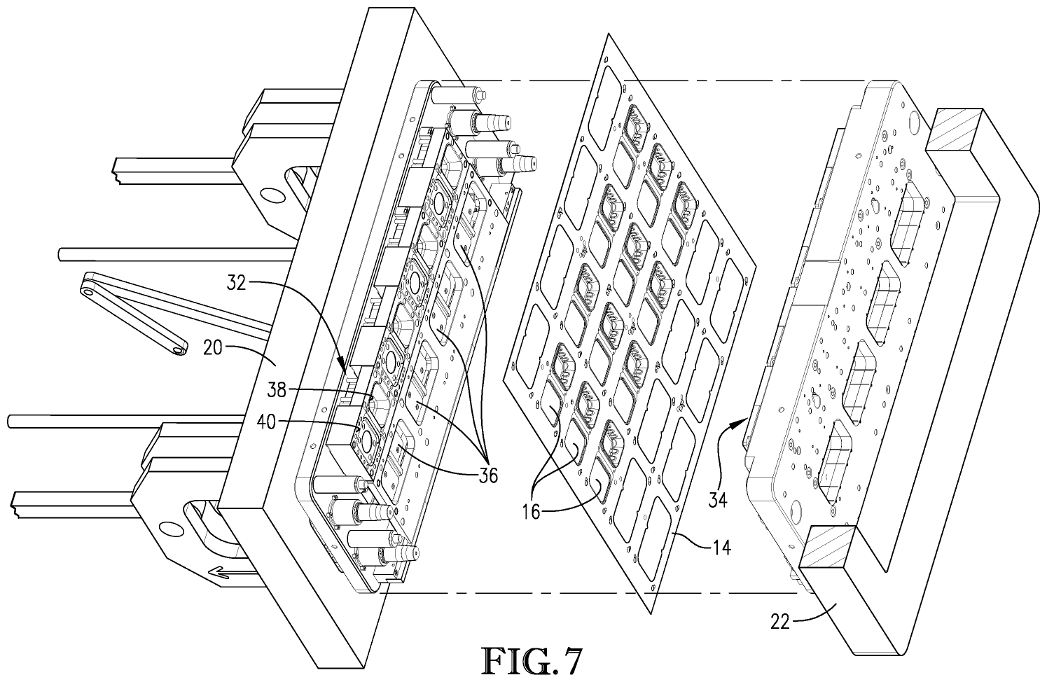

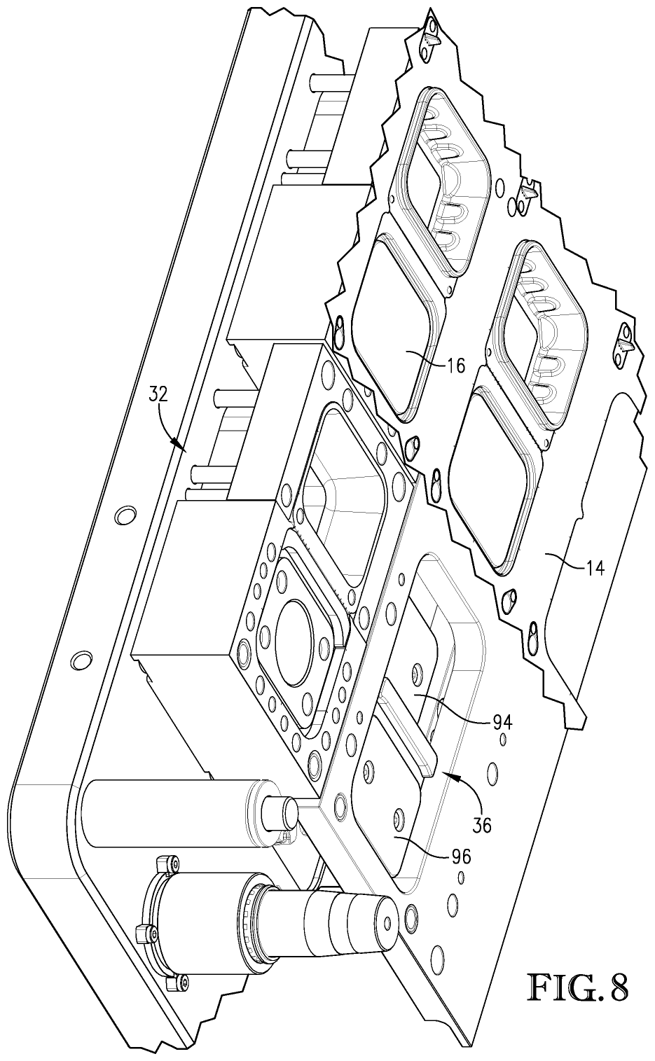

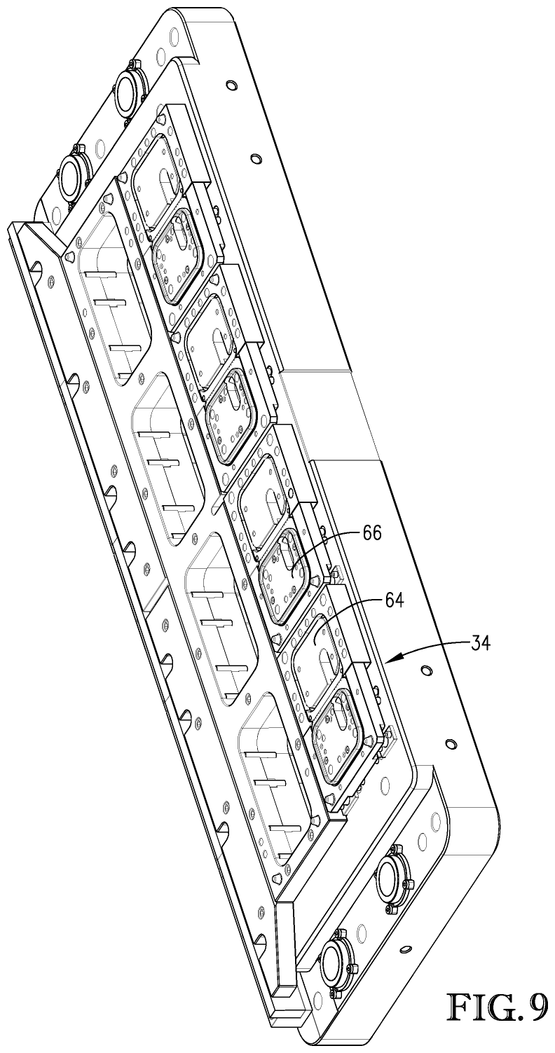

Turning to FIGS. 7-11, a tool 10 constructed in accordance with an embodiment of the present invention is depicted. The tool 10 broadly comprises a first punch and die plate assembly 32 supported on the platen 20, a second punch and die plate assembly 34 supported on the platen 22, and an ejector 36 operable to extend from the first platen 20.

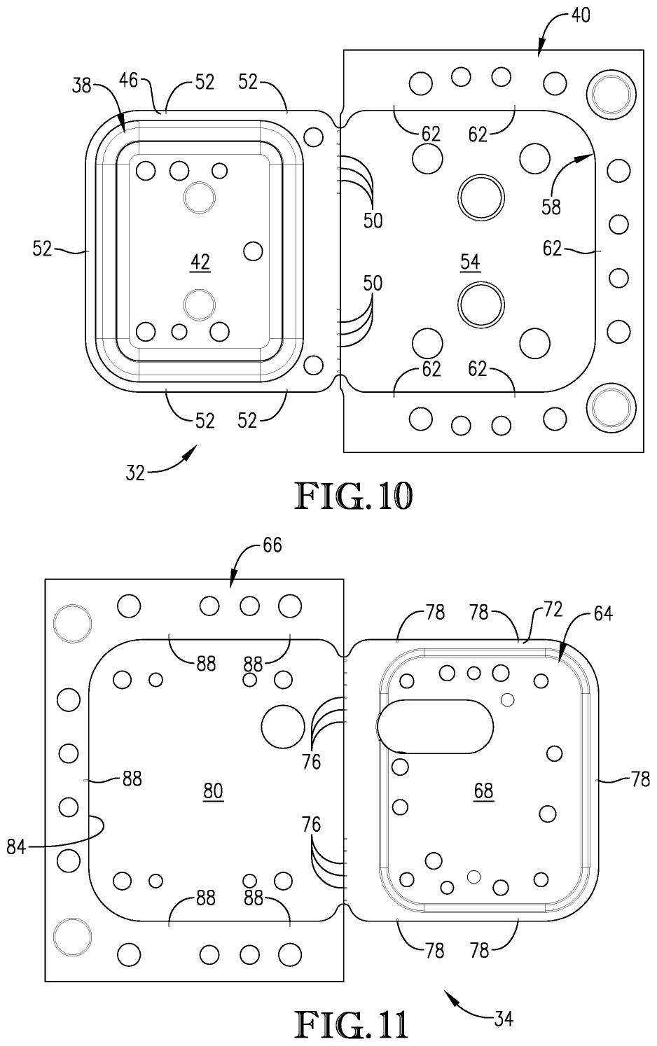

FIG. 10 depicts a portion of the first punch and die plate assembly 32 used to trim one of the parts 16. The other portions of the first punch and die plate assembly 32 for trimming the other parts 16 may be substantially similar. The first punch and die plate assembly 32 comprises a base punch 38 and a lid die plate 40. The base punch 38 is operable to surround the base 26 of the part 16 during the trimming process and support the base 26 during the trimming process. The base punch 38 applies a force to the base 26 to cut a portion of the base 26 from the web 14. The base punch 38 may comprise a surface 42 corresponding to a bottom surface 44 of the base 26, an outer edge 46 corresponding to an edge 48 of the bottom surface 44, a plurality of hinge tear perforation slot nicks 50, and a plurality of web retention slot nicks 52. The hinge tear perforation slot nicks 50 facilitate the formation of the hinge 30 of the part and are formed on a portion of the outer edge 46 of the base punch 26 facing the lid die plate 40. The web retention slot nicks 52 facilitate the formation of chads connecting the base 26 to the web 14, which may be broken when the part 16 is ejected from the web 14.

The lid die plate 40 applies a force on the lid 28 for cutting a portion of the lid 28 from the web 14. The lid die plate 40 may comprise a surface 54 corresponding to a bottom surface 56 of the lid 28, an inner edge 58 corresponding to an edge 60 of the bottom surface 56 of the lid 28, and a plurality of web retention slot nicks 62. The web retention slot nicks 62 of the lid die plate 40 may similarly facilitate the formation of chads connecting the lid 28 to the web 14.

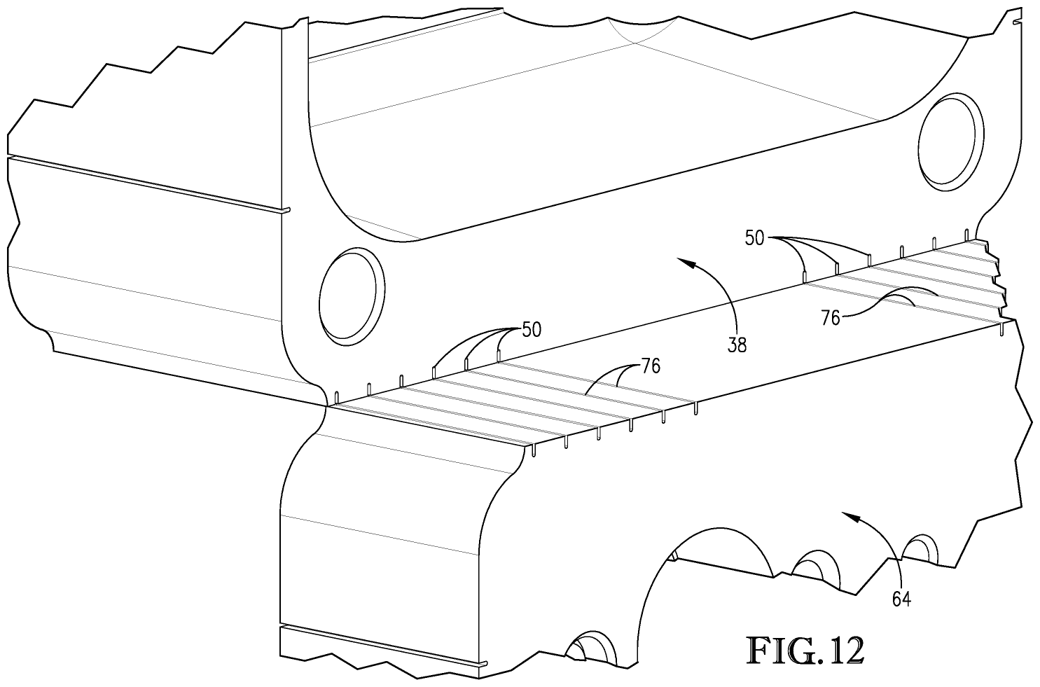

FIG. 11 depicts a portion of the second punch and die plate assembly 34 used to trim one of the parts 16. The other portions of the second punch and die plate assembly 34 for trimming the other parts 16 may be substantially similar. The second punch and die plate assembly 34 comprises a lid punch 64 and a base die plate 66. The lid punch 64 is operable to extend into the lid 28 of the part 16 during the trimming process and support the lid 28 during the trimming process. The lid punch 64 applies a force to the lid 28 to cut a portion of the lid 28 from the web 14. The lid punch 64 may comprise a surface 68 corresponding to a top surface 70 of the lid 28, an outer edge 72 corresponding to an edge 74 of the top surface 70 of the lid 28, a plurality of hinge tear perforation slot nicks 76, and a plurality of web retention slot nicks 78. The hinge tear perforation slot nicks 76 facilitate the formation of the hinge 30 of the part 16 and are formed on a portion of the outer edge 72 facing the base die plate 66. The hinge tear perforation slot nicks 76 may be aligned with the hinge tear perforation slot nicks 50 of the base punch 38 when the tool 10 is actuated, i.e., when the punch and die assemblies 32, 34 meet, as depicted in FIG. 12. The web retention slot nicks 78 facilitate the formation of chads connecting the lid 28 to the web 14, which may be broken when the part 16 is ejected from the web 14. The web retention slot nicks 78 may be aligned with the web retention slot nicks 62 of the lid die plate 40 when the tool 10 is actuated.

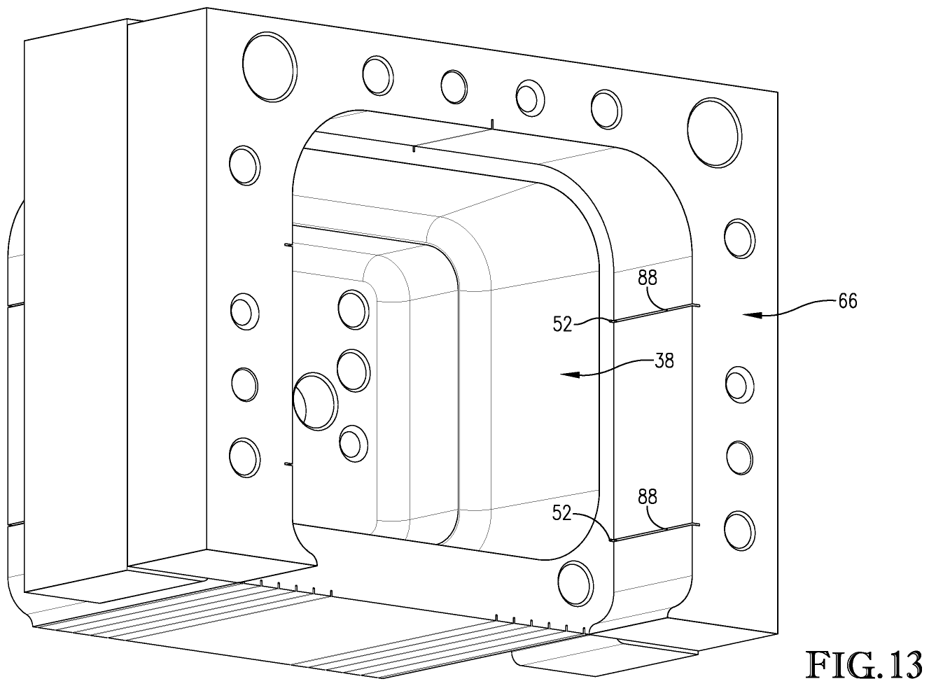

The base die plate 66 applies a force around the base 26 on the web 14 for cutting a portion of the base 26 from the web 14. The base die plate 66 may comprise a surface 80 corresponding to a top surface 82 of the base 26, an inner edge 84 corresponding to an edge 86 of the top surface 82 of the base 26, and a plurality of web retention slot nicks 88. The web retention slot nicks 88 of the base die plate 66 may similarly facilitate the formation of chads connecting the base 26 to the web 14. The web retention slot nicks 88 of the base die plate 66 may be aligned with the web retention slot nicks 52 of the base punch 38 when the tool 10 is actuated, as depicted in FIG. 13.

Returning to FIGS. 3-6, the punch and die plate assemblies 32, 34 cut portions of the part 16 from the web 14. The web retention slot nicks 52, 62, 78, 88 prevent the part 16 from being completely cut away from the web 14 by forming chads 90 connecting the part 16 to the web 14. The hinge tear perforation slot nicks 50, 76 form hinge portions 92 connecting the base 26 to the lid 28. The hinge portions 92 may be torn for separating the lid 28 from the base 26 during use and/or as evidence of tampering of the part 16. However, the punch and die plate assemblies 32, 34 may be configured to form any type of hinge 30 without departing from the scope of the present invention. For example. in some embodiments, the punch and die plate assemblies 32, 34 do not include hinge tear perforation slot nicks 50, 76 and instead do not trim the part 16 along the hinge 30 so that the hinge 30 of the part 16 is a solid piece of material. The trimmed part 16 may have any sized remaining horizontal excess flange without departing from the scope of the present invention. In some embodiments, the trimmed part 16 may have minimal to no remaining horizontal excess flange. Specifically, the edges 48, 86 of the base 26 may define a minimal flange 98 extending horizontally from the base 26, and the edges 60, 74 of the lid 28 may define a minimal flange 100 extending from the lid 28. In some embodiments, the flanges 98, 100 may extend less than 500 micrometers from the base 26 or lid 28, respectively. In some embodiments, the flanges 98, 100 extend less than 250 micrometers.

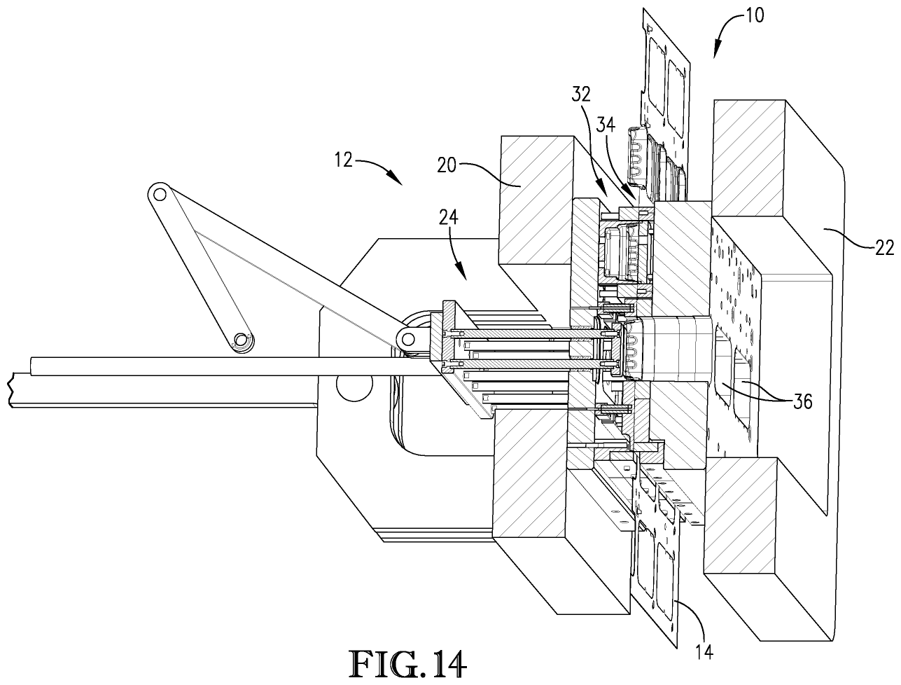

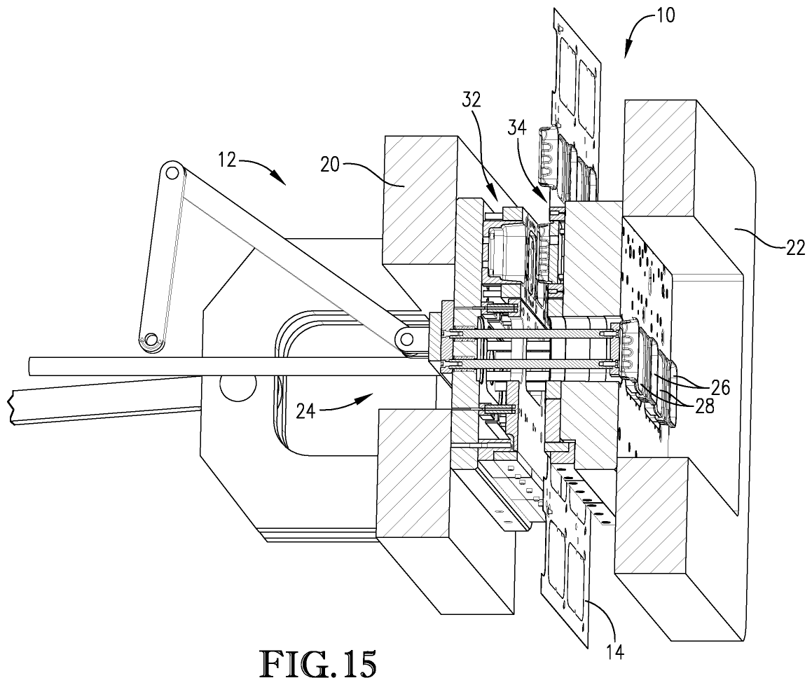

Turning to FIGS. 14 and 15, the ejector 36 is driven by the ejector drive 24 and is configured to separate the part 16 from the web 14 after the part 16 has been trimmed by the punch and die plate assemblies 32, 34. The ejector 36 is configured to be actuated and press against the part 16 (as shown in FIG. 14) so that the chads 90 are broken and the part 16 is separated from the web 14 (as shown in FIG. 15). Returning to FIG. 8, the ejector 36 may comprise a base ejection surface 94 corresponding to the bottom surface 44 of the base 26, and a lid ejection surface 96 corresponding to the bottom surface 56 of the lid 28. When the ejector 36 is actuated, the base ejection surface 94 may press against the bottom surface 82 of the base 26, and the lid ejection surface 96 may press against the top surface 56 of the lid 28. However, the ejector 36 may be configured to press against the part 16 from any direction without departing from the scope of the present invention. For example, the ejector 36 may press against the top surface 82 of the base 26 and the top surface 70 of the lid 28.

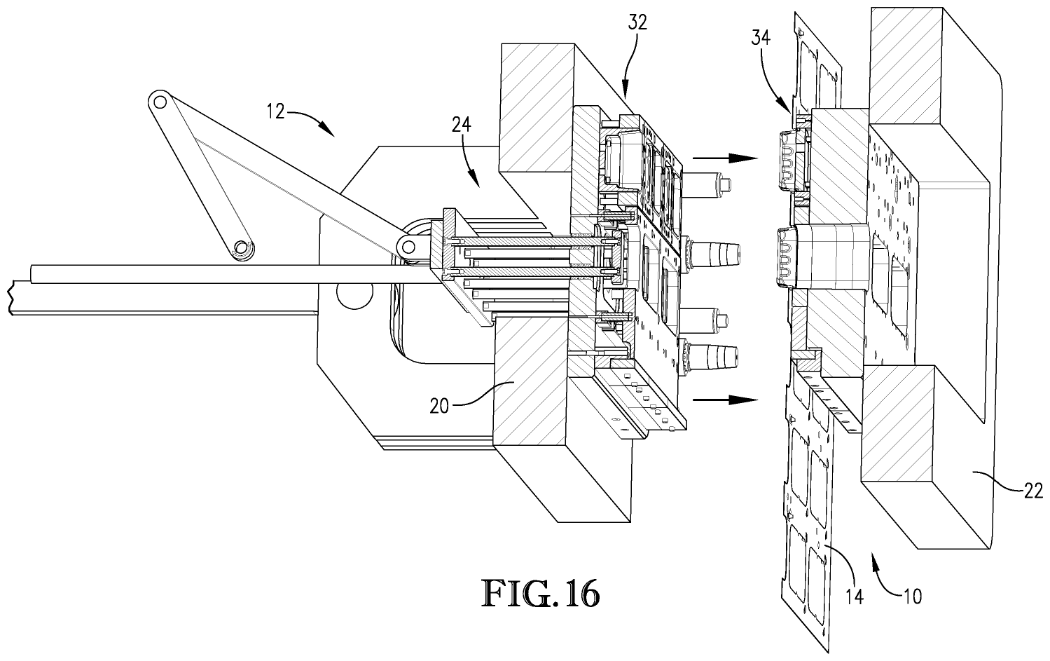

An exemplary method of operating the tool 10 will now be described. The web 14 may be indexed, or positioned, inside the tool 10, as depicted in FIG. 16. The web 14 may be positioned between the punch and die plate assemblies 32, 34 so that the bases 26 and lids 28 of the parts 16 formed in the web 14 are aligned with corresponding base punches 38 and lid punches 64.

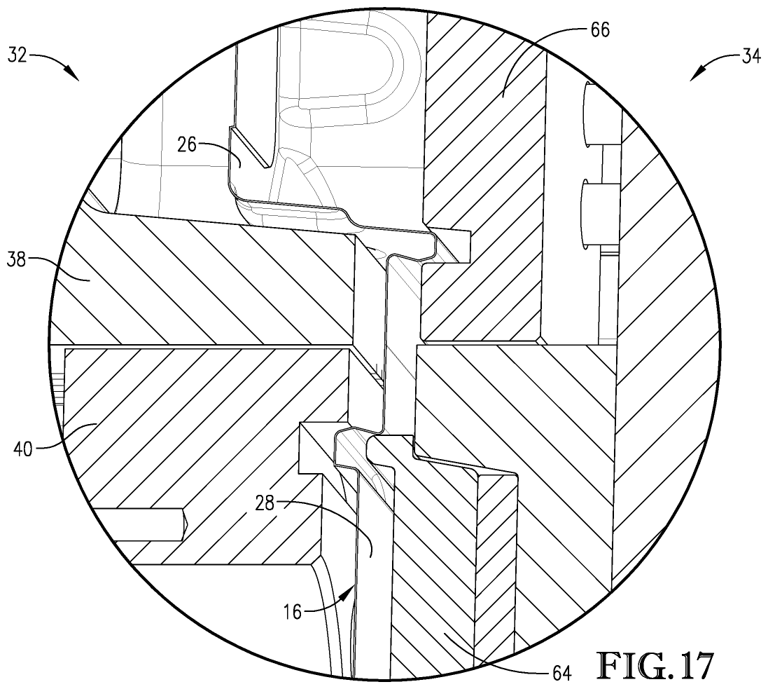

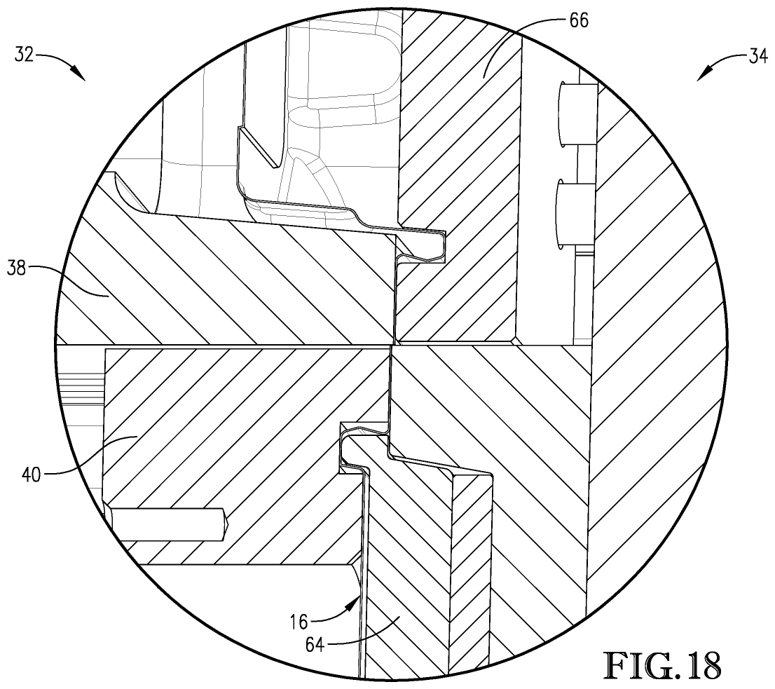

The drive system 18 may actuate the first platen 20 toward the second platen 22, as indicated by the arrows in FIG. 16, so that the tool 10 engages the web 14. As depicted in FIGS. 17 and 18, the base punch 38 may be driven toward the base die plate 66 and engage the base 26 so that the outer edge 46 of the base punch 38 slides against and/or moves in close proximity to the inner edge 84 of the base die plate 66, thereby cutting portions of the base 26 from the web 14. The lid die plate 40 may surround the lid punch 64 so that the inner edge 58 of the lid die plate 40 slides against and/or moves in close proximity to the outer edge 72 of the lid punch 64, thereby cutting portions of the lid 28 from the web 14. In some embodiments, the outer edge 46 of the base punch 38 may extend a predetermined distance passed the outer edge 72 of the lid punch 64 (as shown in FIG. 18) to form the hinge portions 92 the hinge 30. The lid punch 64 may also extend passed the lid die plate 40 a predetermined distance. The predetermined distances can be set to any distance without departing from the scope of the present invention. In some embodiments, the predetermined distances may be less than 300 micrometers, and in some embodiments, between about 100 micrometers and about 275 micrometers.

The web 14 is then indexed so that the trimmed parts 16 are adjacent to the ejector 36. The ejector drive 24 actuates the ejector 36 so that the base ejection surface 94 presses against the bottom surface 82 of the base 26, and the lid ejection surface 96 presses against the top surface 56 of the lid 28. The ejection of the part 16 causes the chads 90 to break, but it does not break the hinge portions 92 connecting the lid 28 to the base 26.

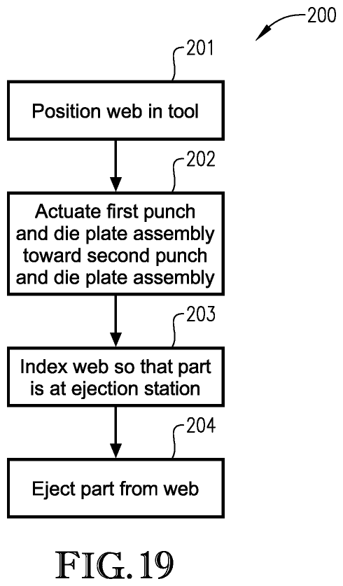

The flow chart of FIG. 19 depicts the steps of an exemplary method 200 of trimming a part with a base and a lid from a plastic web. In some alternative implementations, the functions noted in the various blocks may occur out of the order depicted in FIG. 19. For example, two blocks shown in succession in FIG. 19 may in fact be executed substantially concurrently, or the blocks may sometimes be executed in the reverse order depending upon the functionality involved. In addition, some steps may be optional.

The method 200 is described below, for ease of reference, as being executed by exemplary devices and components introduced with the embodiments illustrated in FIGS. 1-18. However, some of such actions may be distributed differently among such devices or other devices without departing from the spirit of the present invention.

Referring to step 201, the part is positioned in a tool comprising a first punch and die plate assembly and a second, complementary punch and die plate assembly. The first punch and die plate assembly includes a base punch for trimming portions of the base of the part and a lid die plate for trimming portions of the lid of the part. The base punch comprises an outer edge corresponding to an edge of a bottom surface of the base. The lid die plate comprises an inner edge corresponding to an edge of a bottom surface of the lid. The base punch and lid die plate may also have web retention slot nicks formed on their respective outer and inner edges for forming chads connecting the base and the lid to the web material.

The second punch and die plate assembly comprises a base die plate for helping trim the base from the web and a lid punch for extending into the lid die plate and trimming the lid from the web. The base die plate may comprise an inner edge corresponding to an edge of a top surface of the base of the part, and the lid punch may comprise an outer edge corresponding to an edge of a top surface of the lid of the part. The base die plate and lid punch may also have web retention slot nicks formed on their respective inner and outer edges for forming chads connecting the base and the lid of the part to the web. The web retention slot nicks of the base die plate and lid punch may be aligned with the web retention nicks of the base punch and lid die plate, respectively, when the assemblies are actuated toward one another. The lid punch and the base punch may further comprise hinge tear perforation slot nicks on portions of their outer edges facing one another.

Referring to step 202, the first punch and die plate assembly is actuated toward the second punch and die plate assembly so that the outer edge of the base punch and the inner edge of the base die plate cut at least a portion of the base from the plastic web and so that the outer edge of the lid punch and the inner edge of the lid die plate cut at least a portion of the lid from the plastic web, thereby forming a trimmed part. In some embodiments, the base punch may extend into the base die plate a predetermined distance. which may vary based on the material of the web. The base punch may extend into the base die plate any predetermined distance without departing from the scope of the present invention. For example, an edge of the base punch may extend passed the base die plate less than 300 micrometers, and in some embodiments, around 100 micrometers to around 275 micrometers. In some embodiments, the lid punch may extend into the lid die plate a predetermined distance. The lid punch may extend into the lid die plate any predetermined distance without departing from the scope of the present invention. For example, an edge of the lid punch may extend passed the lid die plate less than 300 micrometers, and in some embodiments, around 100 micrometers to around 275 micrometers. This step 202 may include forming the chads and hinge perforations via the slot nicks. The first punch and die plate assembly and/or the second punch and die plate assembly may be actuated without departing from the scope of the present invention. Further, the assemblies may be actuated in any direction/orientation without departing from the scope of the present invention.

Referring to step 203, the web is indexed, or positioned, so that the trimmed part is at an ejection station. The ejection station of the tool may be located adjacent to an ejector of the tool. The ejector is configured eject the part from the web and may comprise a base ejection surface corresponding to the bottom surface of the base and a lid ejection surface corresponding to the top surface of the lid.

Referring to step 204, the part is ejected from the web. The part may be ejected via the ejector driven by an ejector drive. The base ejection surface and the lid ejection surface may press against the base and the lid, respectively, until the chads connecting the part to the web are broken, thereby freeing the part from the web. The ejector may push the part through a channel in a platen.

The method 200 may include additional, less, or alternate steps and/or device(s), including those discussed elsewhere herein.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A method of trimming a part formed in a plastic web, the method comprising:
positioning the part between a tool comprising—
a first punch and die plate assembly comprising—
a base punch having an outer edge corresponding to an edge of a bottom surface of a base of the part, and
a lid die plate having an inner edge corresponding to an edge of a bottom surface of a lid of the part; and
a second punch and die plate assembly comprising—
a base die plate having an inner edge corresponding to an edge of a top surface of the base of the part, and
a lid punch having an outer edge corresponding to an edge of a top surface of the lid of the part; and
actuating the tool so that the first punch and die plate assembly and the second punch and die plate assembly sandwich the plastic web cutting at least a portion of the part from the plastic web.

2. The method of claim 1, wherein the first punch and die plate assembly comprises a first slot nick on the outer edge of the base punch.

3. The method of claim 2, wherein the first punch and die plate assembly comprises a second slot nick on the inner edge of the lid die plate.

4. The method of claim 2, wherein the second punch and die plate assembly comprises a third slot nick on an inner edge of the base die plate in alignment with the first slot nick so that a first chad is formed on the outer edge of the base of the product, the chad connecting the base to the plastic web.

5. The method of claim 4, further comprising ejecting the base from the plastic web, thereby breaking the first chad.

6. The method of claim 3, wherein the second punch and die plate assembly comprises a fourth slot nick on an inner edge of the lid die plate in alignment with the second slot nick so that a second chad is formed on the outer edge of the lid of the product, the chad connecting the lid to the plastic web.

7. The method of claim 2, wherein the second punch and die plate assembly comprises a fifth slot nick on the outer edge of the lid punch in alignment with the first slot nick so that a portion of a hinge is formed during the actuating step, the hinge connecting the base to the lid of the product.

8. The method of claim 1, further comprising positioning the part at an ejection station of the tool, and actuating an ejector to eject the part from the web.

9. The method of claim 8, wherein—
the ejector comprises a base ejection surface corresponding to a bottom surface of the base, and a lid ejection surface corresponding to a bottom surface of the lid; and
the actuating the ejection station step comprises—
pressing the bottom surface of the base with the base ejection surface of the ejection station, and
pressing the bottom surface of the lid with the lid rejection surface of the ejection station.

10. The method of claim 1, wherein the actuating step comprises actuating the tool so that the outer edge of the base punch extends a predetermined distance beyond the inner edge of the base die plate.

11. The method of claim 10, wherein the predetermined distance is around 100 micrometers to around 275 micrometers.

12. The method of claim 1, wherein the actuating step cuts a portion of the base from the plastic web so that the portion of the base has a horizontal flange that is less than 500 micrometers.

13. The method of claim 1, wherein the actuating step cuts a portion of the lid from the plastic web so that the portion of the lid has a horizontal flange that is less than 500 micrometers.

14. A tool for trimming a plastic part with a lid and a base, the tool comprising:
a first punch and die plate assembly comprising—
a base punch having an outer edge corresponding to an edge of a bottom surface of the base of the part, and
a lid die plate having an inner edge corresponding to an edge of a bottom surface of the lid of the part; and
a second punch and die plate assembly comprising—
a base die plate having an inner edge corresponding to an edge of a top surface of the base of the part and operable to receive a portion of the base punch of the first punch and die plate assembly, and
a lid punch having an outer edge corresponding to an edge of a top surface of the lid of the part and operable to extend into the lid die plate of the first punch and die plate assembly.

15. The tool of claim 14, wherein—
the outer edge of the base punch comprises a first plurality of slot nicks formed therein,
the inner edge of the lid die plate comprises a second plurality of slot nicks formed therein,
the inner edge of the base die plate comprises a third plurality of slot nicks formed therein, the third plurality of slot nicks being aligned with and adjacent to the first plurality of slot nicks when a portion of the outer edge of the base punch is positioned adjacent to and partially surrounded by the inner edge of the base die plate, and
the outer edge of the lid punch having a fourth plurality of slot nicks formed therein, the fourth plurality of slot nicks being aligned with and adjacent to the second plurality of slot nicks when a portion of the inner edge of the lid die plate is positioned adjacent to and partially surrounding the outer edge of the lid punch.

16. The tool of claim 15, wherein the base punch comprises a fifth plurality of slot nicks formed therein, and the lid punch comprises a sixth plurality of slot nicks formed therein, the sixth plurality of slot nicks being aligned with and adjacent to the fifth plurality of slot nicks when a portion of the outer edge of the base punch is positioned adjacent to and partially surrounded by the inner edge of the base die plate.

17. A method of trimming an integral plastic product with a base, a lid, and a hinge connecting the lid to the base from a plastic web, the method comprising:
positioning the integral plastic product in a tool comprising—
a first punch and die plate assembly comprising—
a base punch having an outer edge corresponding to an edge of a bottom surface of a base of the part, and
a lid die plate having an inner edge corresponding to an edge of a bottom surface of a lid of the part; and
a second punch and die plate assembly comprising—
a base die plate having an inner edge corresponding to an edge of a top surface of the base of the part, and
a lid punch having an outer edge corresponding to an edge of a top surface of the lid of the part;
actuating the first punch and die plate assembly toward the second punch and die plate assembly so that the outer edge of the base punch and the inner edge of the base die plate cut at least a portion of the base from the plastic web and so that the outer edge of the lid punch and the inner edge of the lid die plate cut at least a portion of the lid from the plastic web;
positioning the integral plastic product at an ejection station; and
ejecting the integral plastic product from the plastic web.

18. The method of claim 17, wherein the outer edge of the base punch comprises a first plurality of hinge slot nicks, and the outer edge of the lid punch comprises a second plurality of hinge slot nicks that align with the first plurality of hinge slot nicks during the actuating step so that a portion of the hinge is formed by the first plurality of hinge slot nicks and the second plurality of hinge slot nicks.

19. The method of claim 17, wherein—
the outer edge of the base punch comprises a first plurality of slot nicks formed therein,
the inner edge of the lid die plate comprises a second plurality of slot nicks formed therein,
the inner edge of the base die plate comprises a third plurality of slot nicks formed therein, the third plurality of slot nicks being aligned with and adjacent to the first plurality of slot nicks during a portion of the actuating step, and
the outer edge of the lid punch having a fourth plurality of slot nicks formed therein, the fourth plurality of slot nicks being aligned with and adjacent to the second plurality of slot nicks during a portion of the actuating step.

20. The method of claim 17, wherein the base punch and base die plate impart a first flange on the base of the integral plastic product, and the lid punch and lid die plate impart a second flange on the lid of the integral plastic product, the first flange and the second flange being less than about 250 micrometers.
